(19) United States
(12) Patent Application Publication
(10) Pub. No.: US 2009/0063646 A1
(43) Pub. Date: Mar. 5, 2009

(54) SYSTEM AND METHOD FOR COLLECTING AND ORGANIZING POPULAR NEAR REAL-TIME DATA IN A VIRTUAL GEOGRAPHIC GRID

(75) Inventor: Craig R. Mitnick, Voorhees, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: NIXLE, LLC, Mount Laurel, NJ (US)

(21) Appl. No.: 12/202,553

(22) Filed: Sep. 2, 2008

Related U.S. Application Data
(60) Provisional application No. 61/037,917, filed on Mar. 19, 2008.
(60) Provisional application No. 60/969,811, filed on Sep. 4, 2007.

(51) Int. Cl. G06F 17/30; G06F 15/16

(52) U.S. Cl. 709/206; 707/10; 707/E17.032

(57) ABSTRACT

A system and method for including a geographical framework to the Internet and permitting users to convey data via mobile devices or computers or to convey universal resource locator values through automated filtering and localizing mechanisms that such data for every geographical location (e.g., longitude/latitude, zip code, etc.) in categories (e.g., news, community information, community economy, community social groups or personal user accounts) that make a more effective and precise use of the Internet. A system and method for interfacing with local, state and federal law enforcement authorities over secure networks for providing, among other things, instant mobile alerts to pertinent localized community members.

### CROSS-REFERENCE TO RELATED APPLICATIONS

This utility application claims the benefit under 35 U.S.C. § 119(e) of Provisional Application Ser. No. 60/969,811 filed on Sep. 4, 2007 entitled SYSTEM AND METHOD FOR INCLUDING A GEOGRAPHICAL FRAMEWORK TO GLOBAL COMPUTER NETWORKS and of Provisional Application Ser. No. 61/037,917 filed on Mar. 19, 2008 entitled SYSTEM AND METHOD FOR COLLECTING AND ORGANIZING POPULAR NEAR REAL-TIME DATA IN A VIRTUAL GEOGRAPHIC GRID and all of whose entire disclosures are incorporated by reference herein.

### BACKGROUND OF THE INVENTION

1. Field of Invention

This invention relates generally to the Internet and, more specifically, to a method and system for including a geographical framework to global computer networks such that data can be collected and organized at a local level, world-wide, for by allowing real geographical communities to populate a new online space for supporting local residents, local government/authorities and businesses in all local communities to provide virtual local alerts/information and local advertising, support virtual local town meetings, as well as providing law enforcement authorities the ability to instantly inform pertinent local communities regarding law enforcement activity in those communities.

2. Description of Related Art

The Internet was designed for the transfer of information or data from link to link, from any one computer to any other computer, or infinite number of computers. It was created as one open worldwide exchange. It was never contemplated by its creators to be utilized by the masses of persons who have adopted it, nor was it ever intended to provide information or communications to “any one set of persons within any one set of geographical boundaries.” The link to link technology of the current Internet was intended to allow any infinite number of computers to access an open pool of information with no geographic restrictions. The technology or processes behind allowing all computers in the world to connect with one another ignore geography as a component. The Internet can simply be defined as an open network between any one computer and any other infinite number of computers, allowing for the transfer of information and data from link to link.

What is known as the “Internet” can be traced to a 1969 network set up by the U.S. Department of Defense. The agency was charged with creating a defense communication network that was robust enough to withstand a nuclear attack. The network was used to connect various military and research facilities, and was also a research project in how to build a reliable intercontinental network. The World Wide Web (www) was developed in the early 1989 in Switzerland as a client-server network. The first browser was developed as well in Switzerland in 1989. The first graphical browser (MOSAIC) was developed at the National Center for Supercomputing Applications (NCSA) at the University of Illinois at Urbana-Champaign and released in January 1993. The first Web search engine was developed in 1993, however it was not until 1994 that the first “full text” crawler-based search engine was created, called WebCrawler. This technology let users search for any word in any webpage, and became the standard for all major search engines since. To date, search methodology remains the most utilized method for accessing information on the Internet.

Address or domain has no correlation to geography, other than for users to register a website in a particular country or region. (e.g., .uk, (England), .de (Germany), etc.). However, it is this very lack of a geographic architecture that has made the Internet so powerful. There are essentially no geographic restrictions for any users to access any information available in the world. But what about the other set of information? The set of local information that needs to operate people's lives day to day. The real-time alerts or information from local police departments concerning safety, or the relevant information from schools that needs to be made instantly available to parents or others. One would think that this sort of information would be available online with today's technology. Ironically, it is this set of local information and communication that either does not exist online, or is not easily accessible online. The same lack of any geographic architecture that has made the Internet so powerful for accessing the world's information is what has also been the cause of most local information and communication to fail online.

Other than by actually knowing an exact web site address, access to information on the Internet is basically restricted by the user's reliance on current search methodology, such as Google. This can be seen by FIG. 1. For example, if a user were searching for “Woodstock's Pizza,” such a search would yield an accurate result, as shown by the search query/results symbol 1a. However, a search for “Mercury” may result in ambiguous information regarding the planet Mercury, the Roman god Mercury and the Mercury automobile, as represented by the search query/results symbol 1b. Further demonstrating this concept, some searches may yield no reliable path to the information desired; for example, as shown by the search query/results symbol 1c, a search for “flowers” yields flower shops, rather than information on plants.

Because the current Internet structure is void of any comprehensive geographic framework, and because domain names have no correlation to true geography, search methodology works incredibly well. The Internet, however, remains an ineffective tool for communication and information that is only relevant to one set of persons within one set of geographic boundaries.

The upshot to this is that people can make purchases from remote locations, or communicate with someone remotely located with extreme ease but when it comes to trying to communicate with local users, the Internet paradigm fails, e.g., if someone loses a dog, posting flyers on telephone poles is still the norm for alerting local residents; local businesses/restaurants cannot provide the same online discounts or coupons that they can so easily provide in circulars or newspapers; and local police departments cannot instantly alert local residents to a danger using the Internet. With no geographical organization, there is no easy and reliable way to communicate with someone based on geographic location either near or far. What is possible is to communicate with someone on the basis of some other means of organizing information, such as Google's search index, if the communication means is so organized.

Thus, the Internet provides an ineffective communication vehicle to use for providing real time relevant information to one set of persons located within one set of geographic boundaries. Unless the Internet's inherent structure is altered to include a comprehensive geographic architecture, the Internet will never be an effective tool for local communication and local information.

All references cited herein are incorporated herein by reference in their entireties.

### BRIEF SUMMARY OF THE INVENTION

A method is disclosed for including a geographical framework upon the Internet and permitting users to provide data relevant to geographic locations to be associated with said geographic locations in said geographical framework. The method comprises: providing a database having a respective repository for each geographic location in the world, each of the repositories adapted for storing information pertinent to its respective geographic location; providing an Internet accessible portal that is coupled to the database, wherein the Internet accessible portal is adapted for permitting users to populate the respective repositories with the pertinent information and permitting users in each of the geographical locations to be informed about the pertinent information in substantially real time; permitting users to convey data via mobile devices or via computers, or to convey universal resource locator values, to the Internet accessible portal; filtering the data conveyed by the users to permit the passage of data that is relevant to news, community information, community economy, community social groups or personal user accounts, to form relevant data; and localizing the relevant data by assigning to each one of the relevant data a content identification and by storing each one of the relevant data in a corresponding repository of at least one geographic location in the database.

A system is disclosed for including a geographical framework upon the Internet and permitting users to provide data relevant to geographic locations to be associated with said geographic locations in said geographical framework. The system comprises: a database having a respective repository for each geographic location in the world, wherein each of the repositories comprises information pertinent to its respective geographic location; an Internet accessible portal that is coupled to the database, wherein the Internet accessible portal permits users to populate the respective repositories with the pertinent information and permitting users in each of the geographical locations to be informed about the pertinent information in substantially real time; a filter that filters data conveyed by users, or by web crawlers that analyze websites of universal resource locator values provided by users, to the Internet accessible portal to permit that passage of data that is relevant to news, community information, community economy, community social groups or personal user accounts, to form relevant data; and a localizer that assigns to each one of the relevant data a content identification and which designates for each one of the relevant data a corresponding repository of at least one geographic location in the database.

### BRIEF DESCRIPTION OF SEVERAL VIEWS OF THE DRAWINGS

The invention will be described in conjunction with the following drawings in which like reference numerals designate like elements and wherein:

FIG. 1 depicts one of the problems of the current architecture of the Internet with regard to searching;

FIGS. 1A-1B provides a block diagram of the present invention referred to as “Nixle” and using “Santa Monica, Calif.” as a drill-down by way of example only;

FIG. 2 depicts the basic structure of the present invention by associating information to every geographic location (by way of example only, the United States) via virtual geographic locations;

FIG. 2A depicts the basic structure of the present invention by associating information to every geographic location (by way of example only, the world) via virtual geographic locations;

FIG. 3 is a graphic for a plurality of virtual geographic locations showing how information pertinent to each geographic location is organized under, by way of example, only five basic categories: news, things to do, personal finance, information and communication for the United States, by way of example only;

FIG. 3A is a graphic for a plurality of virtual geographic locations showing how information pertinent to each geographic location in the world is organized under, by way of example, only five basic categories: news, things to do, personal finance, information and communication for the world, by way of example only;

FIG. 4 is a functional diagram of the filtering and localizing mechanisms of the present invention;

FIG. 5 is an example of a descriptor system using vectors for the State of Texas;

FIG. 6 is an example of a descriptor system using a raster scheme for the State of Texas; and

FIG. 7 is a block diagram of the interface between the present invention and law enforcement's National Law Enforcement Teletype System (NLETS).

### DETAILED DESCRIPTION OF THE INVENTION

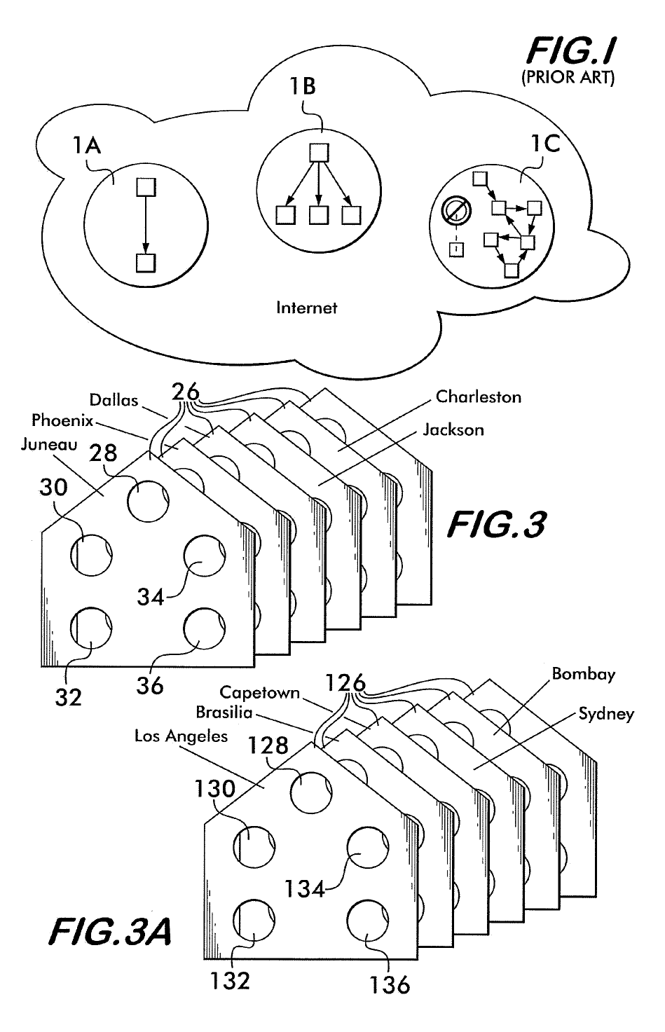

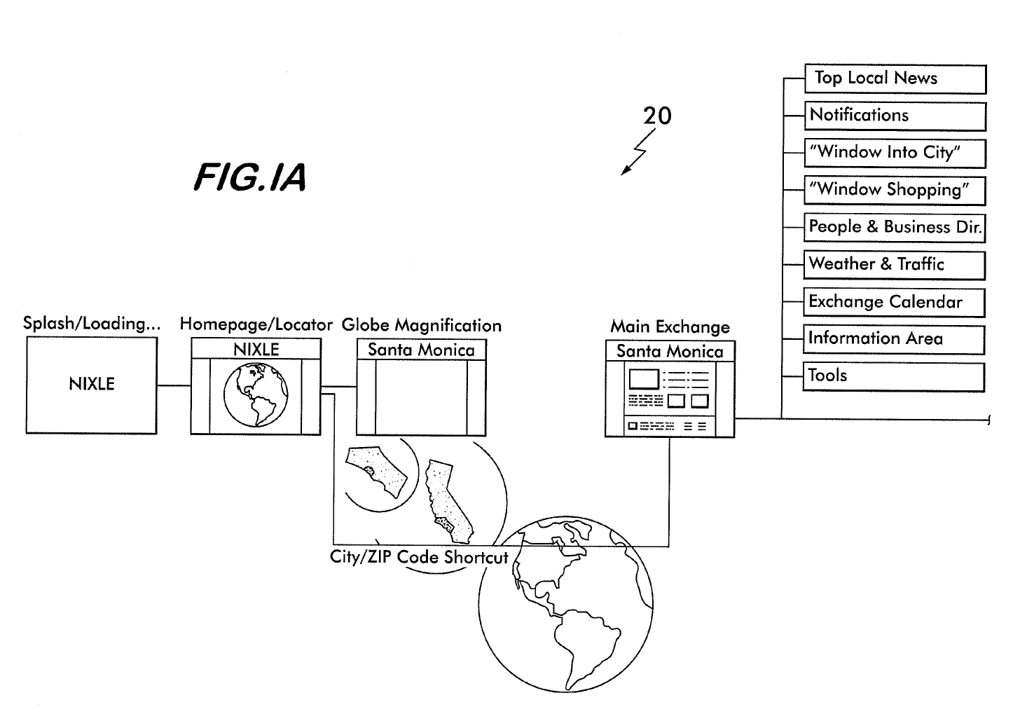

The present invention 20 (also referred to as “Nixle” and as shown in FIGS. 1A-1B) alters the existing Internet configuration by adding a comprehensive geographic framework to the Internet structure. Nixle 20 then provides an exclusive portal into novel geographic space. By altering the Internet's inherent structure with a world geographic configuration (also referred to as a “universal grid architecture,” or “UGA”), the present invention 20 provides the Internet with effective access to information and communication which may only be relevant to “the one set of persons located within the same, one set of geographic boundaries”. Because this “location specific information or communication” is often only relevant to this one set of persons, Nixle 20 breaks down the Internet into geographic space which is then universally defined as some well-defined geographical identifier, for example, but not limited to, longitude/latitude, postal code or zip code worldwide, Congressional or Senatorial district, counties, cities, states, regions, countries, etc.

Nixle 20, and the geographic methodology it creates, is not meant only for the aggregation of existing Internet content, but allows any Internet content to be re-aligned by the content provider if the information would be more accessible and useful when placed into a geographic framework verses open Internet space as it now exists. If the current Internet structure can be pictured as one large mechanism or one world exchange, the geographic interface that Nixle 20 creates allows that vast space or large mechanism to be broken down into smaller exchanges, each defined by a uniform set of geographic boundaries throughout the world, accessible by zip codes or worldwide postal codes. For example, in the United States, each one of the 42,000 zip coded areas each make up one local exchange. Even though each area is a separate local exchange, all exchanges interact with the others, and with the rest of world geography, through a technology (“geographic expansion system” GES) as defined in currently pending patent applications, namely, U.S. application Ser. No. 60/942,841 entitled “System and Method for Providing a Local news, Information and Advertising Portal on the Internet Based on Zip Code” and U.S. application Ser. No. 11/933,818 entitled “System and Method for Permitting Geographically-Pertinent Information to be Ranked by Users According to Users' Geographic Proximity to Information”, and all of whose entire disclosures are incorporated by reference herein. These geographic interfaces along with the underlying algorithms allow all exchanges to interact and create a pioneering real world geographic architecture.

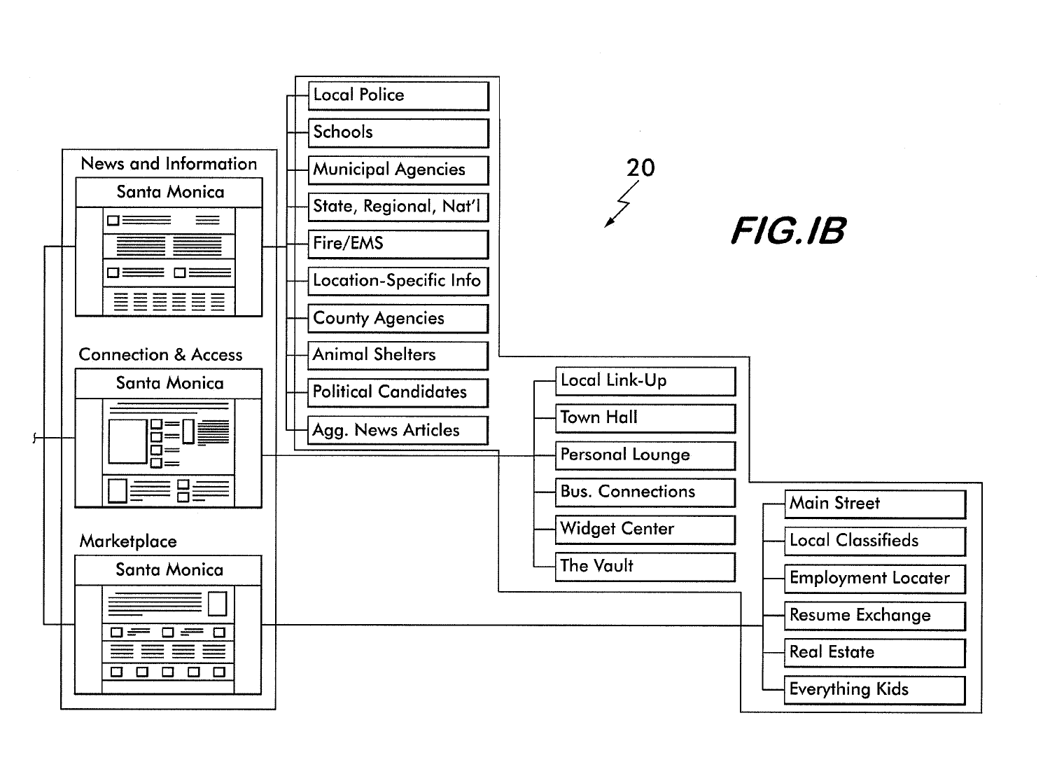

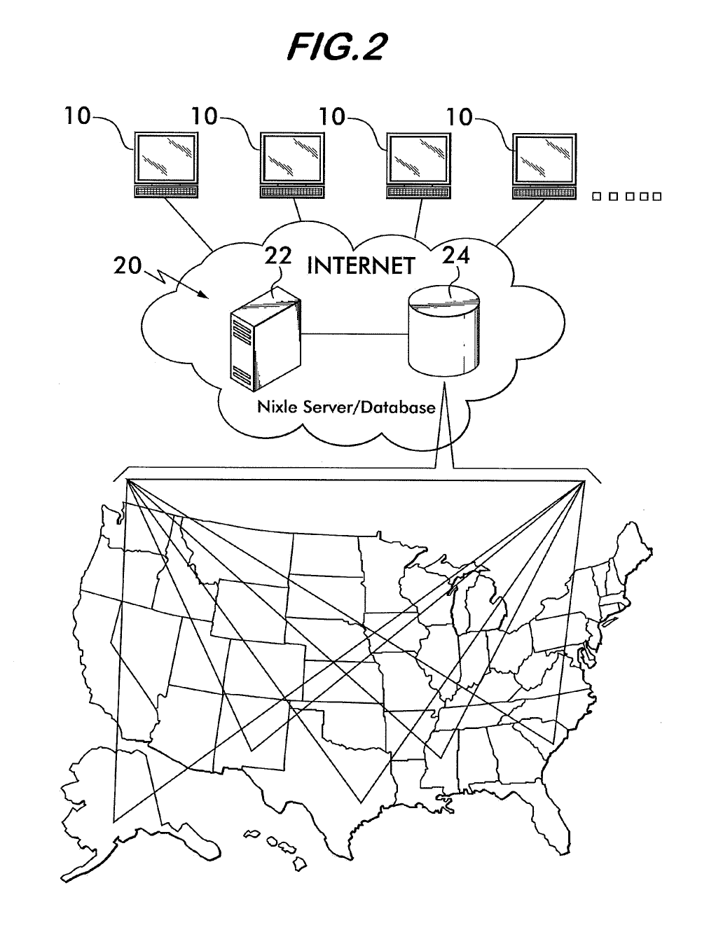

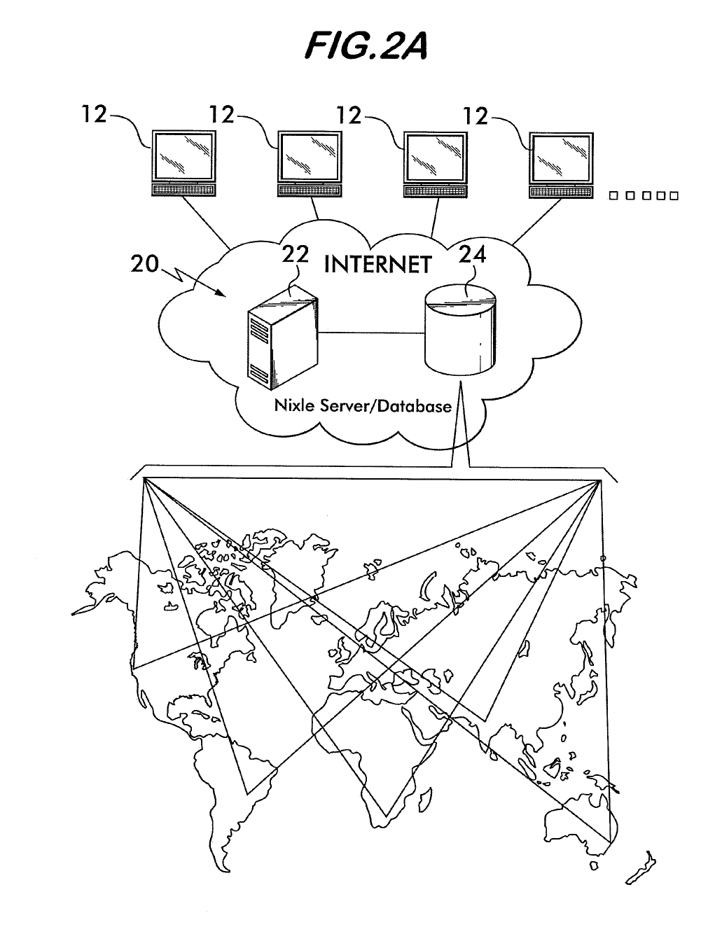

As shown in FIG. 2, instead of a vast open network of domains which have no correlation to geography, Nixle 20 includes a comprehensive geographic structure permits the Internet to be utilized for local communication and information in a way that is now impossible. This geographic framework for Internet space provides the most effective vehicle for real time communication, advertising, and information sharing. In particular, users at corresponding workstations 10, e.g., conducting searches, connect to the Internet and access a Nixle web server 22. The web server 22 is coupled to the Nixle database 24 which provides the virtual geographic architecture for all locations, e.g., by longitude/latitude, zip code, county, state, region, country, or continent, etc. By way of example only, FIG. 2 depicts exemplary virtual geographic location repositories on the database 24 such as: Juneau, Alaska; Phoenix, Ariz.; Dallas, Tex.; Jackson, Miss.; Charleston, S.C. It is within the broadest scope of the present invention 20 every location in the United States, as well as the world, would contain a corresponding geographic location repository on the database 24. By structuring information on the Internet in this manner, this permits much more reliable and consistent access to key information. Although there may be other key structures for organizing such information, the use of “geography” provides a structure that most closely matches the everyday needs of users.

FIG. 2A is similar to FIG. 2 but applies the system and method of the present invention on a world-wide basis.

FIG. 3 is a graphical depiction of several “geographical location repositories” 26 (e.g., those for Juneau, Phoenix, Dallas, Jackson, and Charleston, respectively) that permits every location to have the same basic information. By way of example only, within each geographical location repository (GLR) 26, there are a plurality of widgets: news 28, information center 30, communication and connection 32, main street 34 and personal user account 36. Although this is not an exclusive list, it provides a comprehensive set of categories representing information pertinent to what others typically search on. Thus, the news 28 widget includes local, national, sports, entertainment, etc.; the information 30 widget includes police, emergency, local government, schools, etc.; the communication and connection widget 32 includes, friends, clubs, family, political opinion, etc.; the main street 34 widget includes business, shopping, dining, calendar, entertainment, etc; the personal user account 36 widget includes finance, diary, personal content, etc. All of these are discussed in detail later.

FIG. 3A is a graphical depictions of several “geographical location repositories” 126 on a world-wide basis (e.g., those for Los Angeles, Brasilia, Capetown, Bombay, Sydney, etc.). As with the U.S. model, a corresponding plurality of geographical location repositories (GLRs) 126 are available with each repository comprising a plurality of widgets: news 128, information center 130, communication and connection 132, main street 134 and personal user account 136, as described in the U.S. model for FIG. 3.

Nixle 20 is a local-to-global news and information exchange. One of the key features of Nixle 20 is its use of a real world geographic analog inserted into Internet space as an organizing principle for news, information, services, communications, and community. Nixle 20 segregates, aggregates, and allows for content and services to be realigned based on real world geographic boundaries. This framework makes content accessible to users based on its geographic origination and/or relevance.

Locally, Nixle 20 is a community's source for vital and relevant information from local law enforcement, schools, neighbors, community groups, and national organizations. It is an accessible connection between local merchants and restaurants, and, the real persons who can truly walk through these merchants' front doors.

Nixle 20 breaks down the “one world exchange,” that users have come to recognize the Internet as, into more manageable and relevant subsets or local exchanges. From one locale to the next, worldwide, the Nixle user experience is standardized and familiar, making it easy to access locally relevant information from neighboring communities or from across the globe.

Nixle 20 is a user's hometown homepage, offering a wide and deep engagement with his/her community or neighborhood, and a trusted means for connecting with the world beyond it. Thus, Nixle 20 is a true comprehensive geographic framework and it is inherently valuable because it creates the ability for real-time dissemination of information relevant to any one set of persons within any one set of geographic boundaries including real-time breaking information from police departments, schools, municipalities, and others.

With cell phone technology, increasing numbers of people are attempting to report breaking news in real time, either with pictures or by text. Without a comprehensive geographic framework, the technology that cell phones currently provide throughout the world to relay information cannot be utilized effectively unless the transmissions from those mobile devices can be indexed by geography and then presented within a comprehensive geographic framework to allow accessibility and visibility in real time.

### Nixle 20 Widget System

Nixle 20 comprises a web application that utilizes a plurality of widgets, wherein widgets may be defined as part of a graphic user interface that permits users to interface with the application and operating system and which display information and invite the act in a number of ways; typical widgets include buttons, dialog boxes, pop-up windows, pull-down menus, icons, scroll bars, resizable window edges, progress indicators, selection boxes, windows, tear-off menus, menu bars, toggle switches and forms.

The top tier appears on the main page for any given exchange. Drilling down from that gives second tier widgets and so on, down to more and more focused detail. Navigation features allow a user to easily move up and down the hierarchy. A tree view may be included for allowing the user see the topology and identify a target.

As a user drills down into content, he/she may obtain detail which appears in multiple top-level widgets. Moving “back up” from a widget which appears in multiple higher levels is potentially confusing. When a user “enters” a given location, he/she is presented with a set of “widgets” which provides them with options for accessing and interacting with location specific news and information, as well as national news and information. The widgets also include various communication and connection tools for “everyday people” to connect and interact with others residing in the same geographic location for real time connections. Families and friends who live in diverse geographic locations also have the ability to set up their own dedicated groups to communicate with each other and to exchange personal news, pictures, and video within their own Nixle 20 “lounge.”

These communication and connection tools are similar to those tools used by a different demographic of traditionally younger persons on social networking sites like Facebook and Myspace. Collectively, the Nixle 20 widget system, allows any user to get the most important and relevant information, including real time breaking alerts, in their real location. The widget system also provides the most advanced and effective means for communication and interaction between users within any geographic community, as well as allowing any user the ability to connect with family and friends across the country, and throughout the world. The intent of the geographic framework that Nixle 20 provides is not meant to create an online virtual community but rather to allow existing real geographical communities to populate a new online space.

In addition, Nixle 20 takes into account that it is fundamental that users experience their community's relationship to the complete geographic world space that Nixle 20 creates. Thus, the base Nixle 20 user interface provides the user not only with the experience of being in a given geographic space, but with the experience of being within the complete world geographic space that Nixle 20 represents. Depending on user preference, any widget may be turned on or off depending on what is most valuable to the user personally.

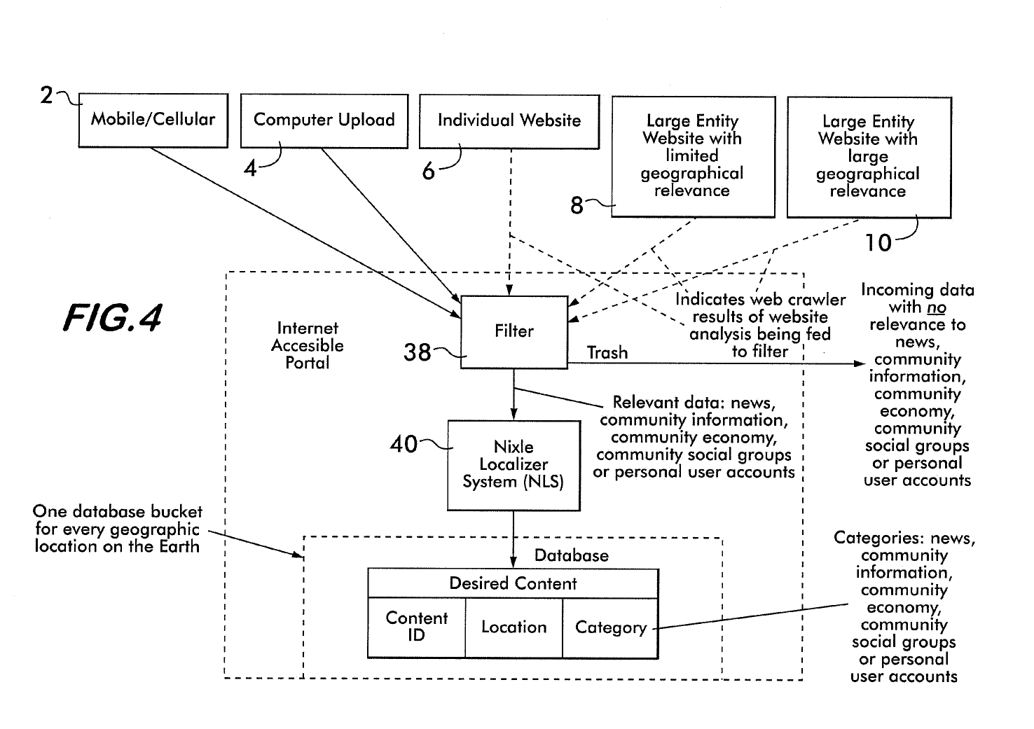

FIG. 4 provides an overview of the filtering and localizing mechanisms of the Nixle 20 system/method. As shown in that figure, the various types of inputs to the Internet accessible portal of Nixle 20, e.g., mobile/cellular 2, computer 4, universal resource locator (URLs) from individual websites 6, URLs from large entity websites with limited geographical relevance 8 and URLs from large entity websites with large geographical relevance 10 are fed through a filter 38 at the portal. It should be noted that, by way of example, web crawlers provide URL content to the filter. The filter 38 removes incoming data with no relevance to the various widgets discussed previously, namely, news, community information, community economy, community social groups or personal user accounts. Next, the filtered information is passed to the Nixle Localizer System 40 (as will be discussed next) and ultimately stored in the proper database repository based on location and content.

### Nixle Localizer System

The localizer technology programmatically analyzes a portion of text to determine geographic associations for the text. The output of the localizer 40 may be several different geographic locations of varying sizes (e.g., a street address, an intersection, a city, a state, a country, etc.). The localizer 40 utilizes a self-training system to improve the accuracy of documents that it is able to localize. In order to train the system, the localizer 40 must have documents which are explicitly localized. Explicit localization can occur through either human input or an explicit semantic match. An explicit semantic match occurs when the system matches a supplied database of terms that are associated with geographic locations. When the system 40 is supplied with explicit semantic matches, the system 40 analyzes the content of the associated texts to determine the aggregate statistical profiles of texts associated with specific geographic areas. Statistical models are generated for potentially overlapping and intersecting areas, because an internal map of relationships between geographic areas is maintained (e.g., San Francisco is in the state of California, which is in North America). When an explicit semantic match results in multiple localities for a single text, the system is able to update statistical models for all associated localities. Once statistical models have been generated, the localizer 40 is able to use these models to determine the likelihood that a text is associated with a specific locality (e.g., every text explicitly localized to “San Francisco” contains “Golden Gate Bridge”, and every text that is not associated with San Francisco never contains “Golden Gate Bridge”, so therefore there is a high probability that a text containing “Golden Gate Bridge” should be localized as “San Francisco”; in this way, the localizer learns that documents containing “Golden Gate Bridge” should be localized as “San Francisco”, even though “Golden Gate Bridge” may not have been in the database of terms used for explicit semantic localization). The likelihood of association is influenced not only by the statistical profile of the texts that have been explicitly localized, but also by the number and nature of explicitly localized texts for a locality.

### Local Search

The local search system is a method of searching and presenting selected data from the UGA of Nixle 20, as mentioned earlier, a database that contains geographic associations for various types of content. In order to perform a search, a user indicates both search term(s) and geographic areas which must be relevant to all results. This may be indicated in various ways, such as entry into a single free-text input which is subsequently parsed to determine the search term components and the location components. Alternatively, the search form may include a free-text input for each set of search terms and an associated number of separate input controls (e.g., a clickable map) to explicitly indicate location specifications. The location may be specified in a number of ways, such as a street address, a city neighborhood, a city, a state, or a continent. After specifying search terms and association locations, the user then signals an input control to perform the search. A set of search results are then presented where all results must satisfy search term matching in addition to location matching. Location matches occurs when the location association for a web resource in the UGA falls within a specified radius whose center is the location specified in the search parameters. If the radius is not specified in the search parameters, then the system selects an appropriate default. For each location specification, the search results include a slider input, called a “Geo-Slide”, which is used to display and change the search location radius. The Geo-Slide is initially set to either the default search radius or the user-specified radius. By way of example only, the range of the Geo-Slide may be relative to the size of the epicenter and may allow discontinuous jumps to national, continental, world, or other transitions. If the user clicks and drags the tab on the Geo-Slide, the search location radius is changed and search results are dynamically shrunk or grown to reflect the new radius. The ordering of the search results is based upon a priority which is a function of numerous factors, including the search radius and GES results. Consequently, it is possible that two different radius settings may result in the same set of results ordered in different ways.

### Rasterized Location Descriptor

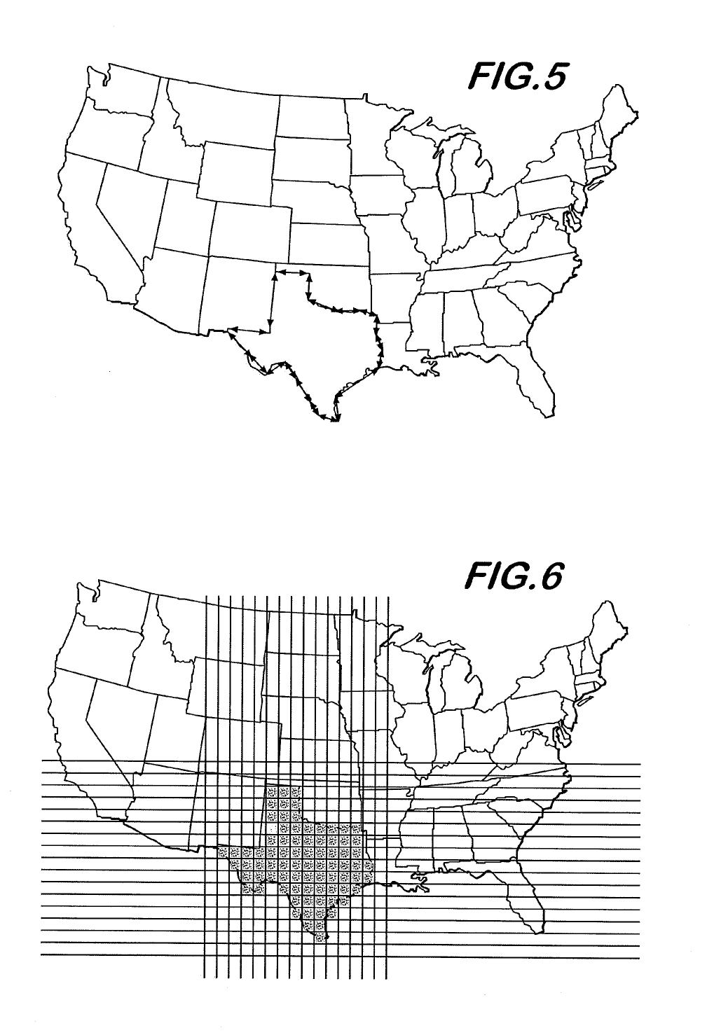

In order to develop a geographic database, it is necessary to develop a methodology of describing a location. For example, in the United States, postal codes and state names can be used to describe locations. However, using these common descriptors has several shortcomings. First, it is not easy to determine the geographic relationships between different descriptors (e.g., what are the intersections of Northwest Philadelphia, Bridesburg and Philadelphia?). Second, some descriptors, such as neighborhood names, are sometimes ambiguous. Third, there are many geographic areas that cannot be described by common descriptors (e.g., a certain section of a road or a specific city block). There are known systems that attempt to solve this problem. For example, one system uses vectors to form an enclosed polygon that outlines any arbitrary geographic location. There are many problems with a vector-based system. For example, it is difficult to use vectors to describe rounded areas (e.g., a circle) using a series of vectors, because a vector is inherently a straight line. In the example of FIG. 5, the state of Texas is represented by a vector system, which demonstrates the difficulty of capturing rounded areas using vectors. In contrast, a rasterized location descriptor system defines a grid which maps a rectangular grid onto the planet Earth. Each grid box represents a square on Earth of a predetermined size (e.g., 10 ft by 10 ft). Locations are then described as black and white images on this rectangular grid. For example, in FIG. 6, the state of Texas is represented using a rasterized system, where grid boxes with a certain amount of land within the borders of Texas are highlighted. These highlighted boxes represent an image of Texas in a rasterized system. The main problem with a rasterized system, as demonstrated by the image of FIG. 6, is that resolution can be an issue, because no matter how small a grid box is defined, a boundary can still run through a grid box. Existing compression techniques for images (e.g., JPEG or PNG format) can be used to optimize storage of rasterized location descriptors. A database maps common descriptors to images on the rectangular grid. The UGA then allows localization with arbitrary location shapes and retrieval from the database based on any sort of geographic relationships (e.g., find all items containing a specific point or overlapping with a specific area).

### Geographic Query Interface

Typical databases, such as Oracle®, have the ability to store various types of information, such as text, images, and video. However, these databases only allow the retrieval of content based on textual analysis. For example, the Oracle® database allows a user to retrieve all records where a particular field in that record contains a certain word. The UGA is unique in that it allows retrieval of records based on geographic descriptors. These geographic descriptors may take several forms, such as rasterized geographic descriptors, vectorized geographic descriptors, specific points (specified by x-y coordinates), and common geographic names. When geographic names are used, the database performs a look-up to determine whether a rasterized or vector-based geographic descriptor exists for a given geographic name. If a descriptor exists then this information is used, and otherwise, the query fails. Queries are performed by specifying a geographic descriptor and an intersection specification. The intersection percentage specifies how much area must overlap between the two geographic descriptors in order for a match to succeed. For example, regular querying permits a searcher to request all records containing a desired word. In contrast, geographic querying permits a searcher to request all records which are at least, e.g., 50%, within the boundaries of a defined region.

The following discussion of the particular widgets is by way of example only and is not an exclusive list for Nixle 20; other widgets may be added to the Nixle 20 system.

### News/Sports/Weather/Traffic Widget 28

From an interface perspective, a top level widget involves a large amount of content, such as news which changes frequently. One way to give the user a “peek” at the content prior to clicking into the next tier widget may include using a national breaking scroll banner, plus the top rated local Nixle 20 headlines.

Weather and traffic may also be included in this widget.

### Nixle Aggregated News

News stories presented in this widget automatically appear where they are most relevant. The technology used to gather and display this content is known as the Nixle “crawler”. This crawler searches out a pre-selected set of existing news sources (approximately 200,000) and then places each story in the location or locations where it is most relevant.

Users in any location have the ability to rate and/or discuss any news article that they read. This “ranking system” allows a news story to be seen by the persons in surrounding geographic areas only if the story is relevant, important, or interesting enough to warrant more attention. Any story or piece of news can become more regional or even national, if warranted by its readers. The details of this “geographic expansion system” (also referred to as GES) is disclosed in U.S. application Ser. No. 11/933,818 entitled “System and Method for Permitting Geographically-Pertinent Information to be Ranked by Users According to Users' Geographic Proximity to Information”, and whose entire disclosure is incorporated by reference herein. In more technical terms, the GES allows any piece of news content to geographically expand outward, in concentric circles, and, on geographic planes, depending on relevance, interest, or importance.

### Professional National News and Highlights Widget

This widget presents a uniform set of national and international news stories to every location in the country. The news content presented in this area is analogous to the content contained in a USA Today newspaper versus a local one. The news is gathered from a limited number of nationally recognized news sources. The news presented is aggregated from a combination of recognized sources rather than from one branded media entity to allow neutrality. Users can rate and discuss this set of content to allow local opinions to emerge from any nationally oriented story. This widget also includes a “breaking national news” item which appears at all times for real time nationally breaking news.

### National Sports News and Highlights

National sports news and highlights are available with this widget. The content presented and available in this area is gathered from a chosen set of professionally recognized media outlets. Users can rate and discuss any piece of content. This widget also includes a breaking sports news banner and updated relevant score card for real time information.

### Entertainment News and Highlights

Entertainment news and highlights are displayed with this national widget. As with the national news and national sports widgets, content presented and available in this area is gathered from a chosen set of credible and recognized entertainment news sources. Users can rate and discuss this set of content.

### Weather

This widget displays the visual 5-day forecast for each location or exchange. The weather content presented also allows for in-depth weather information nationally and internationally. This content is provided by one licensed content partner. From an interface perspective, the “top level” of the weather widget may be dedicated to showing the local weather widget. Viewing national weather is obtained by drilling down below the top-level weather widget. It is also desirable for registered users to have the ability to switch to local weather at a couple of other favorite locations.

### Local Sports

This widget is comprised of two parts. The first area displays local sports stories for the user's location that are pulled from the database of aggregated news sources from the Nixle news crawler. Users are able to expand outward in miles in radius to get any expanded set of local sports news desired. The news content in this area also enters the GES which, as discussed previously, allows appropriate content to geographically expand, if warranted. The second area of this widget includes a set of tools for the local users to set up their own sports categories with accompanying reporting and uploads (leagues, school teams, etc.). Social networking tools apply.

### Information Center Widget 30

From an interface perspective, this is information about each community or location. It has a mixture of both static and dynamic content. It generally comes directly from the source, as opposed to news which comes from a separate source. What is the most important information to show in top level widget? If there is a live streaming broadcast coming up, it is announced. Emergency alerts are handled separately by the alert tool, but also appear at top level as well.

### Schools

The school portion of this widget gives every public, private, or catholic school in the country the ability to instantly communicate alerts and information to its relevant audience. The application allows any school to immediately issue real time information to their local community or any expanded communities, outward in radius of miles if warranted.

The school widget also contains a local school page. The backend interface is only accessible by authorized school personnel, and allows each school to provide any relevant information including school calendars, school events, and contact information. Additionally, the Nixle “crawler” system automatically aggregates and provides additional relevant information to each school respectively.

The interface utilized by the authorized school personnel exists on a secure based web application custom built for Nixle 20 specifications.

### Police Departments

The police widget gives the local police department within each local exchange the ability to instantly communicate alerts and information to its residents. This application allows local police to immediately issue any alert in their local exchange, or in any expanded set of adjoining exchanges outward in radius of miles if warranted (such as in the case of an Amber alert). Via Nixle 20, police departments each have the ability, at no cost to the department, to also send instant mobile text alerts to their registered community residents. The police widget also contains a local police page. The backend interface is only accessible by authorized law enforcement personal, and allows the local department within the exchange to populate its exchange with additional information such as daily arrest logs, assistance requests, ongoing alerts, suspect pictures, broadcasts, etc.

This widget also allows all federal and state law enforcement agencies to push out alerts or relevant information to any location or combination of locations throughout the country.

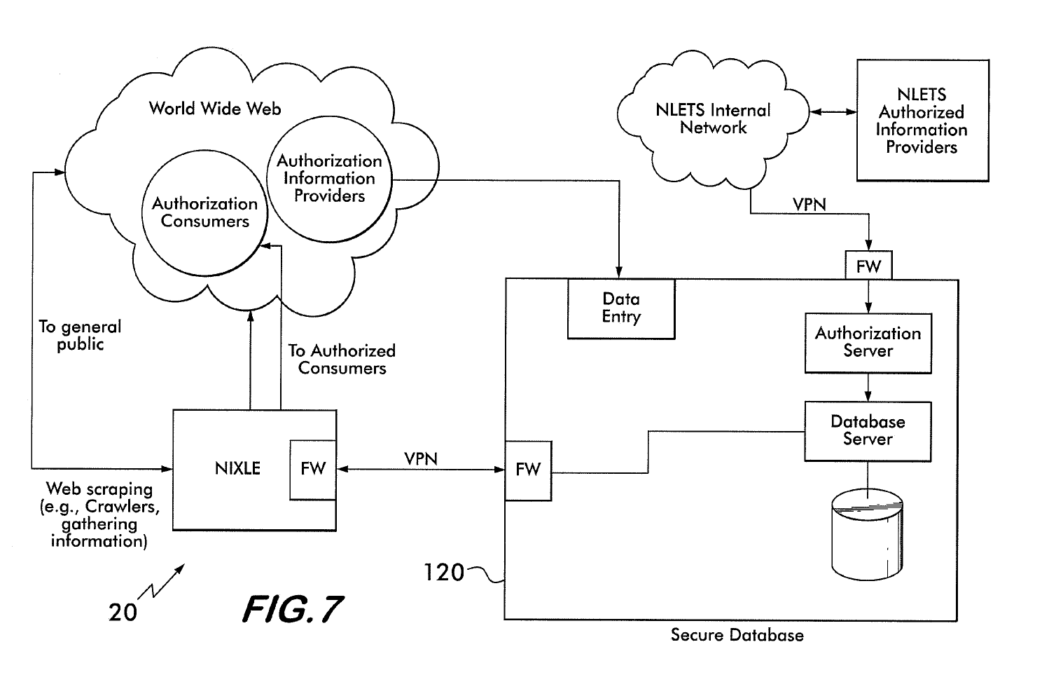

The interface for this widget exists on either a secure based web application, or a custom built API application which can be directly hooked into the NLETS secure network. NLETS (National Law Enforcement Teletype System) is an international, computer-based message switching system that links together state, local and federal law enforcement and justice agencies for the purpose of information exchange. It also provides information services support for justice-related applications via data communications links to state networks using a commercial frame relay service. All agencies within each state are serviced through this state interface. Federal and international systems operate in much the same manner. FIG. 7 depicts an interface between the NLETS system and the present invention Nixle 20.

In order for the Nixle system 20 to interface with the NLETS system, the system 20 implements data security measures which include data validation and verification controls. In the NLETS system there are information users and information owners, the latter referred to as authorized information providers. To make certain that the Nixle system 20 provides a proper interface, there is shown in FIG. 7 a Nixle Information System (NIS) secure database (SD) 120. The NIS-SD 120 includes the following:
(1) Integrity verification programs, such as consistency and reasonableness checks for uncovering such things as data tampering, errors and omissions.
(2) Reconciliation routines (e.g., checksums, hash totals, record counts, etc.).
(3) Where users are allowed to make updates to a database via a web page, these updates are validated to ensure that they are warranted and safe.
(4) Databases containing sensitive information utilize access controls whereby access to certain information is limited to only those persons who require access to it; moreover, the access provides only limited functions (e.g., read, write, modify, etc.) required for those people to perform their duties.
(5) Database servers are configured to only allow connections from authorized, trusted sources, e.g., specific web servers to which they supply information.
(6) For sensitive data, audit trails are created and maintained within the database to track transactions and provide accountability.
(7) Each element of sensitive data must be associated only with and controlled by the Information Owner creator.
(8) Securing sensitive information by selectively encrypting data within the database is preferred.
   Furthermore, programs or utilities that may be used to maintain and/or modify sensitive databases and other software modules which could affect or compromise the confidentiality, integrity, or availability of the data must be carefully acquired and controlled. Databases containing non-public information are not on the same physical machine as a web server. Database, and database servers, that store public information cannot be used to also store non-public (e.g., private, proprietary, sensitive) information. Integrity errors and unauthorized or inappropriate duplications, omissions and intentional alterations will be reported to the Information Owner. Database servers and database software adhere to all Nixle information security policies and procedures pertaining to servers and systems, including patching, hardening, change control, authentication, etc. Compliance with all NIST (National Institute of Standards & Technology) guidelines is met.

The NIS Secure Database (SD) 120 is a set of hardware and software devices that receives messages from the web-based data entry system and the NLETS system, stores then push those messages to the NIS Backend system. The SD 120 interacts with all other NIS subsystems in a secure manner so that the NIS and its data are protected to current government standards.

The SD subsystem provides these functions:
1. The ability to communicate securely over VPN (virtual private network) technology with other NIS subsystems—the Backend, Data Entry and, remote maintenance subsystems.
2. The ability to store the authentication and authorization profiles for each authorized information provider.
3. The ability to securely authenticate the authorized information providers and to authorize their attempted actions using access authorization information provided by the AIP (authorized information provider) data entry process:
4. The ability to digitally sign the messages and verify the signatures to ensure message integrity. It should be noted that the initial signing of the AIP messages is at the Data Entry subsystem. The initial signing of the NLETS messages is at the SD subsystem.
5. The ability to accept an acknowledgement of receipt of messages by the NIS Backend and forward the receipt to the Information providers via the Data Entry subsystem.
6. Firewall (FW) functions where necessary.
7. Sufficient bandwidth for the messages during the test bed period but not to exceed ½ megabit per second average load. Burst bandwidth of 1 megabit per second is available for load testing.
8. Sufficient database capacity to store 60 days of previous messages, not to exceed 50 GB at any one time.
9. Sufficient information is provided with the messages delivered to the NIS Backend to allow the ultimate recipients of the message to identify the originator of the message.

### Fire Departments

Fire departments are under consideration with whether they need their own dedicated page such as schools, police departments, and municipal governments, or whether authorized information access for relevant or breaking communication is sufficient.

### Alerts and Breaking News

When relevant alerts or breaking news occurs in any local exchange, a breaking news flag appears to the user. When a user clicks on the flag, a breaking news widget (viz., a software mechanism that permits users to connect and interact with other in the same geographic location for real time connections) automatically opens with the relevant breaking information contained within. The widget allows for users to provide additional breaking news details utilizing their cell phones, mobile devices, and computers. All user content including text, picture, and video appear in the same open window for continuing real time information. Users can rate or comment on the content and flag it as breaking news. Pictures can be uploaded directly from users cell phones and either sent directly to the live exchange through the Nixle 20 indexing system, or to their registered bin for editing before posting. Pictures may also be uploaded from a user's desktop with or without editing.

### User Authorized Information

This widget contains information that is timely and relevant to the local exchange. Examples of information presented in the area include information from the Center for Disease Control, FDA, American Red Cross, and, all other governmental and organizational entities who have a need to push out relevant information or alerts to any given location or combination of locations.

Authorized users are able to provide information utilizing a secure web based application.

### Town Hall

The Town Hall widget has 2 primary areas. The first area is a streaming live video component which allows users to view live video broadcasts specific to their locale from authorized users. These virtual town hall meetings may range from the broadcast of a school board meeting to a town hall meeting by a Presidential candidate who may speak with any one local exchange or combination of local exchanges depending on chosen geographic location and issues.

The second area of Town Hall is the municipal information area. This is an authorized user area for municipal agencies and officials to upload location specific information with regard to roadways, utilities, calendar events, political information, etc. All authorized access by municipals officials and agencies occur through the use of a secure web based server.

### Communication and Connection Widget 32

For interface design some attached social networking notes are available.

### The Local Linkup

This widget allows users to connect to other people who are geographically local and who share similar interests. Users have the ability to join interest groups, create clubs or leagues, and are able to personally communicate, schedule events and notify the local exchange of public events. This is an organic area for user development.

From an interface perspective: Is there any difference between a linkup group like a motorcycle club which meets in reality, and a group like a family that joins together strictly in virtual space? One difference is public/private. In general, groups would have a couple of characteristics. One is public/private visibility of the group. Another is admission standard which might be open, apply & get approved or invitation only. Each group has an owner (typically the person who started the group) who can remove people and as well as other administrative tasks.

### Lost and Found

This widget provides a communication tool to users in any exchange or surrounding exchanges to notify of lost and found items including pets and material property.

Town Hall Sound Off

This is an area where any user can “sound-off” on local issues they feel are important. The sound-off component includes social networking tools, as well as allowing for public comment. The tools for this widget also include a petition area that any local resident can customize to a particular issue and send out to community registered users for signature.

### Local Auction/Classified Area

Craig's list/eBay area. This widget allows the users within any exchange to utilize the Internet locally in the same way that they can now utilize the classified section of a local newspaper. They may include a pay pal component and/or other revenue components.

### Open Internet

This widget provides individual users throughout the world with a unique ability to upload any content onto the Internet without having to belong to a specific social networking site or have access to any other website server. This widget provides the initial semantic component for the Nixle system 20. Any content “sent into” the Internet initially appears in the local exchange where it was uploaded or posted and then may expand outward in geography depended on relevance, importance, or interest. Any content entered in this area is also searchable worldwide. Content providers have the ability to tag their content with metadata, as well as descriptions. Any user that “enters content onto the Internet” through the Nixle gateway has access to a personal diary and log in his/her user area which gives him/her a geographic visualization of how far his/her content has traveled geographically, as well as where geographically the content has been seen.

From an interface perspective, this is user posted information going through the GES. Semantic encoding of information posted need to have requirements gathered for it. Various types of need can be displayed. This replaces the cell phone exchange.

Because of the novel user experience any user views visually on a globe where any piece of his/her content has been seen around the world, this can be promoted by competitions with substantial rewards, etc.

### Profiles

Community Profiles (registered users in this community with a public profile) There might be two tiers to this, e.g., “real” people who are verified and use their real name and “virtual” people who “live in the community” but who only have a screen name public presence on Nixle 20. This may include a “personal Wikipedia page”. This page would only be editable by the pages creator and is probably only available to verified real people. The page is more a profile form than a freeform Wiki page. People are only able enter in certain facts about themselves and are not able to add random content. In addition, a web monitoring/search service tracks any time something with the user's name appears on the web. The user is notified when his/her name pops up, and has the option of adding a link to his/her personal Wiki profile. Personal messaging (send, receive messages).

### Main Street Widget 34

This widget is directed to the economy for every community.

### Shopping Restaurant, Business

This allows users to explore and be notified of “things to do” in their area. Local, regional, and national businesses can place content online and update it in real time. The business/advertising model allows for any business, corporate to hometown, to utilize a standard template or create as detailed a page as they like.

All business pages include the ability to provide information and discounts in real time, such as dinner specials when a restaurant is having a slow night, to merchandise information, events, or immediate retail coupons. Coupons can be created at any time and in any format, with or without bar-coding. This widget also includes a local exchange entertainment calendar, movie listings, coupon/advertiser browser with subscription access to a user's personal online wallet, as well as a local directory similar to the yellow pages. The advertising model for this widget potentially provides the most effective advertising vehicle for national, regional, and local businesses throughout the world.

Because of the real time information any business has with the set of advertising tools they have available to them, this area can be promoted to a wide array of local restaurants, retail businesses, night clubs, etc.

### Movie Listings

This content is directed to a licensed content provider area.

### Entertainment Calendar

From an interface perspective, overlaps may occur between this type of calendar and events scheduled for Local Link groups, and, events that might be aggregated or added by authorized users from a municipal and school calendar.

### Dining and Restaurants

This is directed to restaurants and food establishment area.

### Personal User Account Widget 36

From an interface perspective, this is the user's identity in the community and in life. It is only available to registered users. What do users want available at a glance? Which of their friends are online? Possibly, a quick way to switch profiles if allowed to alternate profiles. This also includes displaying any private messages waiting. Non-registered users are able to create new registered accounts here. Registered users are able to access their account settings.

### Username/Password

This widget permits alternate screen names/profiles. People can do it anyway by creating multiple accounts, and this may be permitted by allowing the creation of multiple names in a single account. Alternatively, there may be multiple levels of personal identification beyond just creating a username and password. For instance, a credit card or cell phone might verify that the person really is the person with the name provided.

### Friends List

How many roles/permission levels can a friend have? A friend is a role where you give privilege to a special set of people. Friendship could be defined both one-way and mutual or only mutual. In one-way, a special privilege (i.e., they can see if a user is online, or view special pictures) can be granted to certain people. If it is mutual, then there must be an invitation/acceptance to friendship. It is desirable to allow multiple levels of friendship with different privileges.

Local Linkup Groups to which the user belongs. Drilling down on this widget eventually takes the user into the Local Linkup area of the Communication & Connection area. See details in local linkup.

### Business Networking (Linked In)

This may share characteristics with a trust network.

Create a personal and/or professional resume which will exist on a Wikipedia-like page for professional networking and internet identity.

### Financial

Wallet subscriptions & current contents. The user can view the current contents of his/her wallet. They can set up or delete new subscriptions. This functionality merges into business/shopping browse & search functionality for local merchants.

Personal finance. This area of financial management portfolio is provided by a large United States financial/bank/partner. The financial portfolio management tool centralizes any user's personal financial information, and allows a user to Utilize secure application to manage their complete financial portfolio. The strategic bank or financial partner has not yet been chosen.

### Personal Messaging

Users can send and receive messages with other Nixle 20 users. This area may also include tools which allow authorized users the ability to generate contributions through a verified secure pay pal component. Examples include everything form a local fire department raising funds to contributions for a national disaster, such as Hurricane Katrina.

### Preferences

This must provide a flexible user interface that accommodates new settings easily, such as a multi-tier type structure. A set of wizards which handhold users through the most important setups, an expert interface with access to most settings, and a possible access to raw settings file.

### Subscriptions

Text message notifications from authorized users.

### Globe & Diary

A dairy is provided to every registered user. This log or listing of each piece of content that a user enters into the open internet creates a novel user experience by allowing a visualization of where the content was viewed around the world (Globe image marked with where content was entered geographically, marked with every area in the world where someone has seen the piece of content, and how far content has expanded outward through patented technology).

The log and globe shows both a temporal view of what a user has put on the internet, and a geographical view of where it was consumed. In addition to this feature, users will also be provided editing tools for pictures and video content they have uploaded. Editing services are available for some supported content types. Users can also manage whether the content posted is public or private.

### Personal Holding Bin

This shows private content a user has uploaded, but to which no other users have access. Includes all cell phone images sent directly to bin. This area also includes editing tools to enhance or edit content before posting live.

The following tools are always available to the user on the site.

### Alerts

When relevant alerts or breaking news occurs in any local exchange, a breaking news flag appears to the user. When a user clicks on the flag, a breaking news widget automatically opens with the relevant breaking information contained within. The widget allows for users to provide additional breaking news details utilizing their cell phones, mobile devices, and computers. All user content including text, picture, and video appears in the same open window for continuing real time information.
Public Safety (Law enforcement)
Weather
Breaking News (from Nixle editorial)
Other authorized users.
Private message waiting. A user most wants to know if he/she has a private message when he/she is on the site. This feature is user-configurable.

### Community Search

This is directed to finding something in a user's community (e.g., find something on the user's local exchange.) Keyword searching or category searching and by item type (i.e., find me the police, which should take this person to the police's “My Space” page).

### Open Internet

Upload something to a user's local exchange or his/her personal bin. This feature allows users to upload content located at a particular geographic location. In addition, a simple interface is provided that allows the user to inform the system about the uploading and (as much as possible) encode that information in a semantic store. Antivirus software/protections are to be implemented at this point. This widget provides individual users throughout the world with a unique ability to upload any content onto the Internet without having to belong to a specific social networking site or have access to any other website server. This widget provides the initial semantic component for the Nixle system 20. Any content “sent into” the Internet initially appears in the local exchange where it was uploaded or posted and then may expand outward in geography depended on relevance, importance, or interest. Any content entered in this area is also searchable worldwide. Content providers have the ability to tag their content with metadata, as well as descriptions. Any user that “enters content onto the internet” through the Nixle 20 gateway have access to a personal diary and log in his/her user area which gives him/her a geographic visualization of how far their content has traveled geographically, as well as where geographically the content has been seen.

### Change Location

Allows a user to go to a different local exchange. For registered users, they also have a “my passport” set of quick links to favorite locations.

### Outside Elements

There are potentially several other interfaces to Nixle 20 for standard, as opposed to privileged/authorized users. These may include:

Desktop client: This allows access to Nixle data without going through a browser. It runs natively on the host operating system. It may be a dashboard plugin on OS X or a system tray app on Windows.
Browser Toolbar: A browser plugin which highlights one or two most important pieces of information Nixle has. This integrates Nixle into the user's web experience no matter where website they're currently at.
Moble UI (user interface): This is a version of the web UI that is optimized to view and work on a standard cell phone browser.
iPhone UI: This is a version of the web UI optimized to view and work on an Apple iPhone. It should be understood that this UI is by way of example only and it is within the broadest scope of the present invention to include UI's for other similar wide band “iPhone clones” (e.g., Instinct, Atom, Windows® Mobile, Google's Android platform-based phone, etc.)

While the invention has been described in detail and with reference to specific examples thereof, it will be apparent to one skilled in the art that various changes and modifications can be made therein without departing from the spirit and scope thereof.

What is claimed is:

1. A method for including a geographical framework upon the Internet and permitting users to provide data relevant to geographic locations to be associated with said geographic locations in said geographical framework, said method comprising:
providing a database having a respective repository for each geographic location in the world, each of said repositories adapted for storing information pertinent to its respective geographic location;
providing an Internet accessible portal that is coupled to said database, said Internet accessible portal adapted for permitting users to populate said respective repositories with said pertinent information and permitting users in each of said geographical locations to be informed about said pertinent information in substantially real time;
permitting users to convey data via mobile devices or via computers, or to convey universal resource locator values, to said Internet accessible portal;
filtering said data conveyed by the users to permit the passage of data that is relevant to news, community information, community economy, community social groups or personal user accounts, to form relevant data; and
localizing said relevant data by assigning to each one of said relevant data a content identification and by storing each one of said relevant data in a corresponding repository of at least one geographic location in said database.

2. The method of claim 1 wherein said step of localizing said relevant data further comprises storing each one of said stored relevant data into a respective category within said corresponding repository.

3. The method of claim 2 wherein respective categories comprise news, community information, community economy, community social groups or personal user accounts.

4. The method of claim 1 wherein said step of permitting users to convey data via mobile devices or via computers, or to convey universal locator values, comprises instructing crawlers to analyze the websites of each universal resource locator value and to retrieve data from said websites that is passed through said filtering step.

5. The method of claim 3 wherein said news category includes local news, national news, sports news or entertainment news.

6. The method of claim 3 wherein said community information category includes police issues, emergency issues, local government issues or school issues.

7. The method of claim 3 wherein said community social groups category comprises information related to friends, clubs, family or political opinion.

8. The method of claim 3 wherein said community economy category comprises information related to business, shopping, dining, calendar and entertainment.

9. The method of claim 8 wherein said personal user account category comprises information related to finance, diary, or personal content.

10. The method of claim 1 wherein each geographical location is defined by a longitudinal coordinate and a latitudinal coordinate.

11. The method of claim 1 wherein each geographical location is defined by a postal code or zip code.

12. The method of claim 1 wherein each geographical location is a town or city.

13. The method of claim 1 further comprising the step of retrieving database records based on rasterized or vectorized geographic descriptors.

14. The method of claim 13 wherein said step of retrieving database records comprises permitting a searcher to specify a percentage of how much overlap between two geographic descriptors may occur for determining a query match.

15. The method of claim 1 further comprising the step of providing a second database that is secured for interfacing with said Internet accessible portal and an international, computer-based message switching system that links together state, local and federal law enforcement and justice agencies, said second database permitting the issuance of instant mobile text alerts to pertinent local communities based on law enforcement activity.

16. A system for including a geographical framework upon the Internet and permitting users to provide data relevant to geographic locations to be associated with said geographic locations in said geographical framework, said system comprising:
a database having a respective repository for each geographic location in the world, each of said repositories comprising information pertinent to its respective geographic location;
an Internet accessible portal that is coupled to said database, said Internet accessible portal permitting users to populate said respective repositories with said pertinent information and permitting users in each of said geographical locations to be informed about said pertinent information in substantially real time;
a filter that filters data conveyed by users, or by web crawlers that analyze websites of universal resource locator values provided by users, to said Internet accessible portal to permit that passage of data that is relevant to news, community information, community economy, community social groups or personal user accounts, to form relevant data; and
a localizer that assigns to each one of said relevant data a content identification and which designates for each one of said relevant data a corresponding repository of at least one geographic location in said database.

17. The system of claim 16 wherein said localizer further designates a respective category within said corresponding repository to which each one of said relevant data is to be stored.

18. The system of claim 16 wherein respective categories comprise news, community information, community economy, community social groups or personal user accounts

19. The system of claim 16 further comprising crawlers that are instructed to analyze the websites of each universal resource locator value and which retrieve data from said websites that are passed through said filter.

20. The system of claim 16 wherein said news category includes local news, national news, sports news or entertainment news.

21. The system of claim 16 wherein said community information category includes police issues, emergency issues, local government issues or school issues.

22. The system of claim 16 wherein said community social groups category comprises information related to friends, clubs, family or political opinion.

23. The system of claim 16 wherein said community economy category comprises information related to business, shopping, dining, calendar and entertainment.

24. The system of claim 16 wherein said personal user account category comprises information related to finance, diary, or personal content.

25. The system of claim 16 wherein each geographical location is defined by a longitudinal and latitude coordinate.

26. The system of claim 16 wherein each geographical location is defined by a postal zip code.

27. The system of claim 16 wherein each geographical location is by a town or city.

28. The system of claim 15 further comprising a second database that is secured for interfacing with said Internet accessible portal and an international, computer-based message switching system that links together state, local and federal law enforcement and justice agencies, said second database permitting the issuance of instant mobile text alerts to pertinent local communities based on law enforcement activity.
